(19) United States
(12) Patent Application Publication
(10) Pub. No.: US 2026/0171908 A1
(43) Pub. Date: Jun. 18, 2026

(54) CONTROL SYSTEM FOR CONTROLLING A FLYING CAPACITOR

(71) Applicant: Renesas Design (UK) Limited, Bourne End (GB)

(72) Inventors: Janko Celikovic, Chandler, AZ (US); Dhanraj UMESH AMIN, Chandler, AZ (US)

(73) Assignee: Renesas Design (UK) Limited, Bourne End (GB)

(21) Appl. No.: 18/979,920

(22) Filed: Dec. 13, 2024

(51) Int. Cl. H02M 3/07; H02M 1/00

(52) U.S. Cl. CPC H02M 3/07; H02M 1/0003

(57) ABSTRACT

A control system for a switching converter including a flying capacitor and a first power switch. The control system includes a control circuit for generating a first pulse width control signal, having a first rising edge and first falling edge, to determine a state of the first power switch. The control system further includes a sensing circuit for sensing a voltage error of a flying capacitor voltage of the flying capacitor relative to a target voltage and generating a modulation signal based on the voltage error of the flying capacitor voltage, and a correction circuit for receiving the modulation signal and the first pulse width control signal and for modulating the first rising edge and/or the first falling edge based on the modulation signal to provide a corrected first pulse width control signal to the first power switch.

### FIELD

The present disclosure relates to a control system for controlling a flying capacitor; in particular, a system and a method for controlling a flying capacitor;

### BACKGROUND

Multi-level power converters are widely used in applications requiring high power density and efficiency, such as portable devices, wearable electronics, and Internet of Things (IoT) systems. These converters benefit from reduced voltage stress across power switches, lower inductor ripple currents, and minimized electromagnetic interference.

Among multi-level converter topologies, a flying capacitor multi-level (FCML) converter has gained prominence for its ability to achieve wide conversion ratios, distribute voltage stresses across switches, and reduce switching losses and seamless operation in buck and boost modes.

The FCML converter relies on a flying capacitor to distribute voltages across multiple power switches and reduce switching losses. To maintain optimal operation, the flying capacitor voltage must be regulated to a predetermined target which is half of input voltage in a typical three level flying capacitor converter. Precise control of this voltage is critical to prevent voltage overstress on power switches, maintain a triangular inductor current waveform, and minimize power losses.

However, maintaining the flying capacitor voltage at the desired level presents significant challenges. Voltage imbalances can arise from variations in circuit parameters such as timing mismatches, unequal power switch resistances, and parasitic capacitances can lead to a mispositioned flying capacitor voltage. Furthermore, in practical applications, rapid changes in input voltage or load demand exacerbate the difficulty of flying capacitor regulation. Conventional “natural balancing” mechanisms are often insufficient to track these dynamic changes, leading to instability and inefficiency. In severe cases, inadequate regulation of the flying capacitor voltage can result in catastrophic failure of the power switches, as excessive voltage stress across individual switches may exceed their rated limits, causing thermal runaway or permanent damage.

Attempts to address the challenges of these regions have included strategies such as differential duty cycle modulation, phase-shifting techniques, and external circuitry for balancing the flying capacitor voltage. While these methods improve performance under certain conditions, they often suffer from limitations such as instability near specific operating points, inefficacy in some DCM regions, and increased system complexity due to additional hardware requirements.

Known methods for flying capacitor regulation can perform well in specific operating regions, such as continuous conduction mode (CCM) or certain conversion ratios, but fail in others, such as discontinuous conduction mode (DCM) under high or low conversion ratios. More specifically, high conversion ratio (HCR) refers to scenarios where the output voltage (Vₒᵤₜ) is greater than half the input voltage

$$( \frac{{V}_{i n}}{2} )$$

while low conversion ration (LCR) applies when

$${V}_{out} < \frac{{V}_{i n}}{2} .$$

These distinctions exist in both CCM and DCM, and the effectiveness of regulation methods depends on the interplay of these regions.

It would, therefore, be beneficial to provide a solution to one or more these challenges.

### SUMMARY

According to a first aspect of the disclosure, there is provided a control system for a switching converter comprising a flying capacitor and a first power switch, the control system comprising: a control circuit configured to generate a first pulse width control signal to control the first power switch, the first pulse width control signal determining a state of the first power switch and having a first rising edge and first falling edge; a sensing circuit configured to sense a voltage error of a flying capacitor voltage of the flying capacitor relative to a target voltage and generate a modulation signal based on the voltage error of the flying capacitor voltage; and a correction circuit configured to receive the modulation signal and the first pulse width control signal and configured to modulate the first rising edge and/or the first falling edge based on the modulation signal to provide a corrected first pulse width control signal to the first power switch, thereby regulating the flying capacitor voltage of the flying capacitor.

Optionally, the switching converter comprises a second power switch; the control circuit is configured to generate a second pulse width control signal to control the second power switch, the second control signal determining the state of the second power switch and having a second rising edge and second falling edge; and the correction circuit is configured to receive the second pulse width control signal and is configured to modulate the second rising edge and/or the second falling edge based on the modulation signal to provide a corrected second pulse width control signal to the second power switch.

Optionally, the switching converter comprises a third power switch and the correction circuit is configured to provide the corrected first pulse width control signal to the third power switch, the state of the third power switch being complementary to the inverse state of the second power switch as controlled by the corrected second pulse width control signal; and/or the switching converter comprises a fourth power switch and the correction circuit is configured to provide the corrected second pulse width control signal to the fourth power switch, the state of the fourth power switch being complementary to the inverse state of the first power switch as controlled by the corrected first pulse width control signal.

Optionally, the correction circuit is configured to:
modulate the first rising edge and/or the first falling edge based on a differential duty cycle modulation parameter and/or a phase shift parameter; and/or
modulate the second rising edge and/or the second falling edge based on the differential duty cycle modulation parameter and/or the phase shift parameter.

Optionally, the correction circuit is configured to modulate the first falling edge based on the differential duty cycle modulation parameter; and/or the correction circuit is configured to modulate the second rising edge based on the differential duty cycle modulation parameter and the phase shift parameter; and/or the correction circuit is configured to modulate the second falling edge based on the phase shift parameter.

Optionally, the correction circuit comprises a plurality of delay elements configured to independently modulate one, two, three or four of: the first rising edge; the first falling edge; the second rising edge; and the second falling edge.

Optionally, the correction circuit is configured to modulate: the first rising edge equal to a first constant; the first falling edge equal to the differential duty cycle modulation parameter and/or a phase shift parameter multiplied by a first modulation variable; the second rising edge equal to sum of the differential duty cycle modulation parameter and/or a phase shift parameter multiplied by a first modulation variable; the second falling edge equal to the differential duty cycle modulation parameter and/or a phase shift parameter multiplied by a first modulation variable;

Optionally, correction circuit is configured to modulate: the first rising edge equal to −1 multiplied by a first modulation variable; the first falling edge equal to a first constant; the second rising edge a first constant; the second falling edge equal to 1 multiplied by a first modulation variable.

Optionally, wherein the first correction signal to the first power switch is generated based on:

$${i}_{Cfly} \approx 2 {I}_{L} Δ d + \frac{{V}_{o u t}}{{f}_{s} L} D Δ φ ;$$

and/or:
the first correction signal to the first power switch is generated in based on:

$${i}_{Cfly} \approx 2 {I}_{L} Δ d + \frac{{V}_{i n} - {V}_{o u t}}{{f}_{s} L} ( 1 - D ) Δφ .$$

Optionally, at least one of the plurality of delay elements is adjustable based on the modulation signal for precise timing control of the first pulse width control signal and/or the second pulse width control signal.

Optionally, the sensing circuit comprises: a transconductance amplifier configured to generate a modulation signal based on a proportional current to the voltage error of the flying capacitor.

Optionally, the transconductance amplifier comprises an integral gain component having an integral current and wherein the modulation signal is based on the combination of the proportional current and the integral current.

Optionally, the sensing circuit comprises: a buffer configured to stabilize a reference signal having a static reference voltage.

Optionally, the correction circuit comprises a comparator circuit configured to compare the reference signal based on modulation signal with the ramp signal and generate the control signal.

Optionally, the comparator circuit includes a resistor ladder network configured to adjust the control signals delay through comparison with the ramp signal.

Optionally, the control circuit is configured to regulate the voltage of the flying capacitor configured to operate within a continuous conduction mode (CCM) and a discontinuous conduction mode (DCM) operation and across a plurality of operating regions comprising: a low conversion ratio (LCR); a high conversion ratio (HCR); and a 50% conversion ratio operation

Optionally, the converter comprises an input voltage and the sensing circuit is configured to:
i) measure the input voltage of the converter; and/or
ii) measure output voltage of the converter

Optionally, the control circuit and the correction circuit are configured to provide stable regulation of the flying capacitor voltage during transitions between continuous conduction mode (CCM) and discontinuous conduction mode (DCM) operation.

Optionally, the correction circuit comprises a set-reset latch configured to maintain the sequencing of the first correction signal and the second correction signal.

Optionally, the modulation signal is generated to maintain the voltage of the flying capacitor at approximately half the input voltage of the converter.

Optionally, the switching converter is a multi-level converter.

Optionally, the switching converter is a buck converter, a boost converter or a buck-boost converter.

According to a second aspect of the disclosure, there is provided a method of controlling a switching converter comprising a flying capacitor and a first power switch, the method comprising: generating a first pulse width control signal to control the first power switch, the first pulse width control signal determining a state of the first power switch and having a first rising edge and first falling edge; sensing a voltage error of the flying capacitor relative to a target voltage and generating a modulation signal based on the voltage error of the flying capacitor; and modulating the first rising edge and/or the first falling edge based on the modulation signal to provide a corrected first pulse width control signal to the first power switch, thereby regulating the flying capacitor voltage of the flying capacitor.

### BRIEF DESCRIPTION OF THE DRAWINGS

The disclosure is described in further detail below by way of example and with reference to the accompanying drawings, in which:

FIG. 1A is schematic of a known 3-level converter in a demagnetizing state;

FIG. 1B is schematic of a known 3-level converter in a magnetizing state;

FIG. 1C is schematic of a known 3-level converter in a flying capacitor charging state;

FIG. 1D is schematic of a known 3-level converter in a flying capacitor discharging state;

FIG. 2 is a known low conversion ratio pulse width modulated control signal graph 200 for the 3-level converter;

FIG. 3 is a known high conversion ratio pulse width modulated control signal graph for the 3-level converter;

FIG. 4A is a known switching node voltage graph for the 3-level converter;

FIG. 4B is a known inductor current graph for the 3-level converter;

FIG. 5 is a known pulse width modulation active balancing graph for active flying capacitor;

FIG. 6 illustrates an operating region graph of a duty cycle 604 and the inductors 104 load current;

FIG. 7 illustrates a dual edge triangular modulation graph for the 3-level converter;

FIG. 8 illustrates a failure mechanism graph;

FIG. 9 illustrates a phase shift control scheme using phase shift control;

FIG. 10 illustrates a phase shifted control graph depicting the limitations of the phase shift control scheme in LCR DCM;

FIG. 11 is a schematic of a system for regulating the voltage of the converter having the flying capacitor in accordance with a first embodiment of the present disclosure;

FIG. 12 is a graph of a 3-edge modulation operation for the edge modulation in accordance with the first embodiment of the present disclosure;

FIG. 13A is a graph of a first gain profile for the edge modulation method for when input voltage is constant in accordance with the first embodiment of the present disclosure;

FIG. 13B is a graph of a second gain profile when the output voltage of the converter is constant in accordance with the first embodiment of the present disclosure;

FIG. 14 is graph of an LCR DCM operation in accordance with the first embodiment of the present disclosure;

FIG. 15 is a graph of an HCR DCM operation graph in accordance with the first embodiment of the present disclosure;

FIG. 16 is a diagram of the correction circuit and sensing circuit receiving the Cfly error in accordance with the first embodiment of the present disclosure;

FIG. 17 is a schematic of an implemented correction circuit in accordance with a second embodiment of the present disclosure;

FIG. 18 is a schematic of a correction circuit configured to initiate one-shot pulses of a minimum on or off duration in accordance with a third embodiment of the present disclosure;

FIG. 19A is a schematic of a second implemented correction circuit in accordance with a fourth embodiment of the present disclosure;

FIG. 19B is a schematic of a third implemented correction circuit 1900b in accordance with a fifth embodiment of the present disclosure; and

FIG. 20 is a diagram of a second correction circuit and the sensing circuit receiving the Cfly error in accordance with the sixth embodiment of the present disclosure.

### DETAILED DESCRIPTION

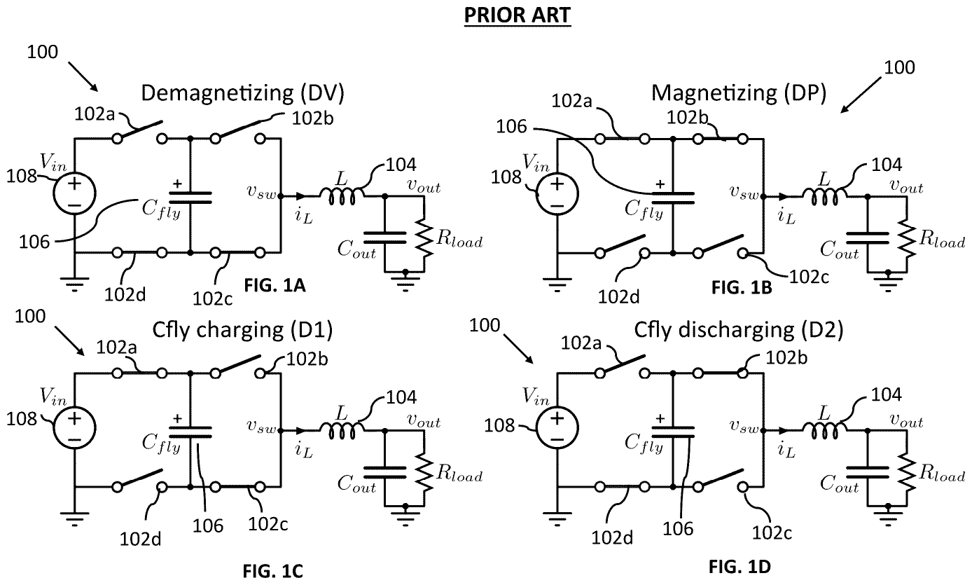

FIG. 1A is schematic of a known 3-level converter 100 in a demagnetizing state. FIG. 1B is schematic of a known 3-level converter 100 in a magnetizing state. FIG. 1 is schematic of a known 3-level converter 100 in a flying capacitor charging state. FIG. 1D is schematic of a known 3-level converter 100d in a flying capacitor discharging state. FIGS. 1A, 1B, 1C and 1D of the known 3-level converter 100 will now be described and may share commonality across all components.

The 3-level converter 100 includes 4 switches 102a, 102b, 102c, 102d. The 3-level converter further includes an inductor 104, a flying capacitor 106 and input voltage source 108.

The four power switches 102a, 102b, 102c and 102d are arranged in a half-bridge or similar configuration. The switches may be referred to as the flying capacitor (Cfly) 106 is positioned to generate intermediate voltage levels. The inductor 104 is provided for energy storage, switching frequency filtering and current control.

The 3-level converter 100 operates in 4 state operations; the demagnetizing state, the magnetizing state, the flying capacitor charging state (Cfly charge) the flying capacitor discharging state (Cfly discharge). A brief explanation based on the described states is now provided.

The states are defined by the combination of switch 102a, 102b, 102c & 102d positions and their effects on the inductor 104 and flying capacitor 106.

Switching States are as follows:

A Demagnetizing (DV) State: switch 102c and switch 102d active (ON): switch 102a and switch 102b inactive (OFF). In operation the inductor current maintains current flow without applying voltage 108 to the inductor 106. The inductor current is maintained without contributing to magnetization to the flying capacitor 104.

A Magnetizing (DP) State: switch 102a and switch 102b ON, switch 102c and switch 102d OFF. In operation, the inductor 106 is connected directly to the input voltage source 108, thereby magnetizing it and increasing its current.

A Cfly Charging (D1) State: switch 102a and 102c ON, switch 102b and 102d OFF. In operation, the flying capacitor charges as it is placed in the converter 100 circuit path, transferring energy to align its voltage closer to an intermediate voltage of the input voltage source 108. The flying capacitor 106 is charged, ensuring an intermediate voltage level is maintained.

A Cfly Discharging (D2) State: switch 102b and switch 102d ON, switch 102a and switch 102c OFF. In operation, the flying capacitor 106 discharges, providing energy to the inductor 104 and an output load. The capacitor voltage is reduced while ensuring steady energy delivery to the load.

Pulse Width Modulation (PWM) Control is now described. Two complementary PWM signals may be used to control the switches, thereby controlling between the 4 states DV, DP, D1, D2, ensuring that the transitions between magnetizing, demagnetizing, and capacitor balancing states are smooth. Adjusting the periodic duty cycle of the PWM signals allows control of the output voltage, while maintaining the flying capacitor voltage at approximately half the input voltage.

### Voltage Levels

The converter fundamentally processes power by utilizing three distinct voltage levels:
Full input voltage (DP state);
Half input voltage (D1 or D2 states with Cfly balancing);
Ground/zero voltage (DV state).

One challenge with the 3-level converter 100 is the precise control of the flying capacitor voltage across charging and discharging states is critical for stability. Switch timing mismatches or dynamic load conditions can lead to voltage imbalance or increased losses.

The 3-level converter 100 has the capability to operate in both buck and boost modes while achieving wide conversion ratios, the 3-level converter offers several key advantages over conventional 2-level designs.
1. 2 times reduced voltage stress across power switches 102a, 102b, 102c, 104d and effectively smaller switch size
2. 2 times higher inductor 104 frequency
3. 4 times lower peak inductor 104 current ripples, reducing inductor loss and size.

By reducing size and loss of the power switches 102a, 102b, 102c, 102d, and the inductor 104, the topology of the 3-level converter 100 is an ideal candidate for next-generation power conversion in portable devices. However, these advantages are compromised unless the flying capacitor (Cfly) 104 voltage is precisely controlled to the half of the input voltage source (Vin) 108.

Because of the inherently unpredictable nature of the flying capacitor voltage, active control is often essential to ensure stable and optimal converter 100 operation. This control process is commonly referred to as “balancing”. While the flying capacitor 106 voltage can in some cases converge to its ideal value without external interference, a process known as “natural balancing,” this method is typically slow and unreliable. Therefore, active flying capacitor voltage regulation is imperative for this topology.

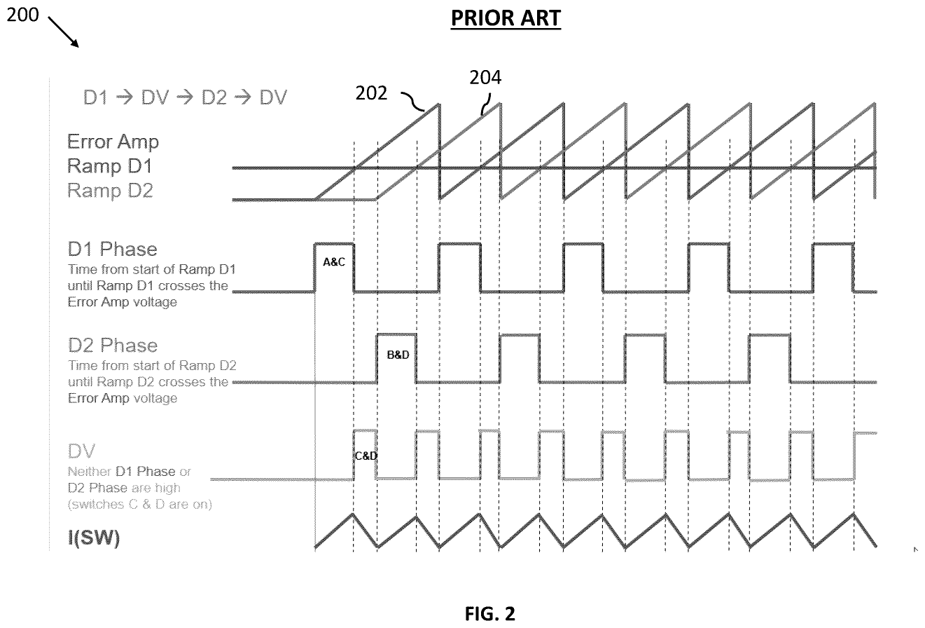

FIG. 2 is a known low conversion ratio pulse width modulated control signal graph 200 for the 3-level converter 100.

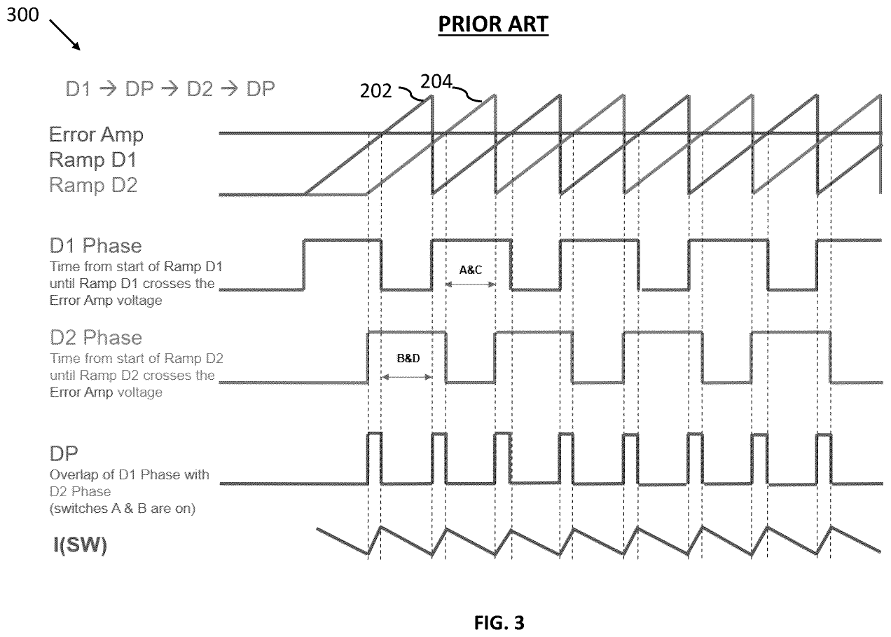

FIG. 3 is a known high conversion ratio pulse width modulated control signal graph 300 for the 3-level converter 100.

The known pulse width modulated control signal graphs 200, 300 includes a pair 202, 204 of pulse-width control signal that are 180 degrees shifted in phase. The sequence of the switches 102a, 102b, 102c, 102d are governed by the pulse-width modulation, as illustrated in FIG. 2 and FIG. 3. FIG. 2 depicts a low conversion ratio (LCR) mode of operation and FIG. 3 depicts a high conversion ratio (HCR) mode of operation, wherein high refers to the duty cycle of the pulse width control signals 204, 204 that the switches remain ON for a longer than in LCR to allow more energy transfer to the output and increase the inductor's magnetizing current.

The role of the flying capacitor 104 varies depending on the conversion ratio and operating conditions. The flying capacitor is most actively engaged near the boundary between high conversion ratio (HCR) and low conversion ratio (LCR), where Vₒᵤₜ=0.5*Vᵢₙ defines a boundary. At this boundary, the flying capacitor 104 continuously balances charge to support energy exchanges. However, as the converter operates deeper into HCR (Vₒᵤₜ approaching Vᵢₙ) or deeper into LCR (Vₒᵤₜ approaching 0), the flying capacitor 104 becomes less engaged, as its energy exchange requirements decrease.

It is also important to note that HCR does not always imply higher power operation. While HCR corresponds to higher output voltage, the actual power delivered depends on the load demand, which can be low even at high voltages.

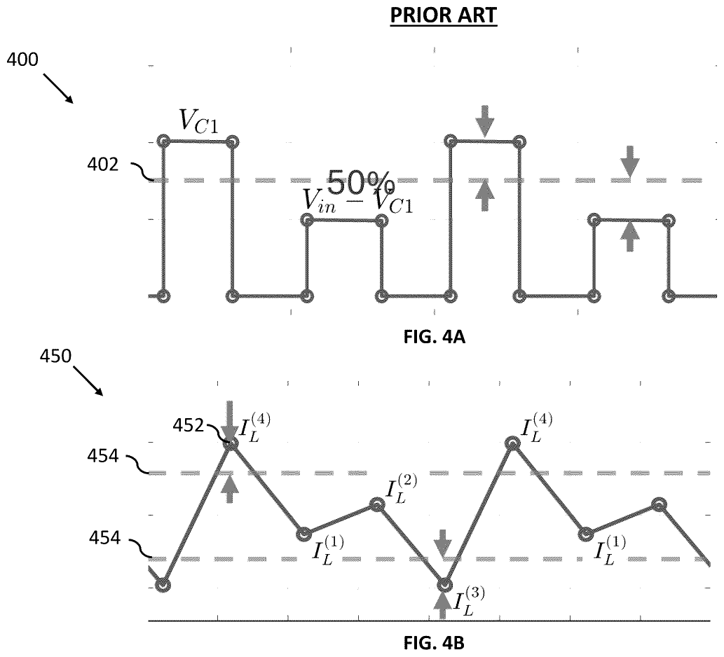

FIG. 4A is a known switching node voltage graph 400 for the 3-level converter 100. FIG. 4B is a known inductor current graph 450 for the 3-level converter 100.

FIGS. 4A and 4B depict the effects of a mispositioned flying capacitor 104, where the flying capacitor voltage exceeds a threshold 402 of 50% of the input voltage source 108. This imbalance causes proportional voltage overstress on the switches 102a, 102b, 102c, 102d and deviations 452 in the inductor 104 current from an expected boundary 454 of the triangular waveform, which in turn leads to an increased root mean square (RMS) current and greater power loss.

The natural balancing mechanism in the 3-level converters 100 is generally weak, making the flying capacitor 106 prone to divergence from the desired voltage level. There are multiple reasons for the mispositioning, including:
1. Mismatched timing of the charging and discharging switching states, caused by skew in the rise and fall times of the gate driver circuitry and other internal timing imperfections.
2. Unequal field effect transistor (FET/switch) resistance, causing unequal power.
3. Imbalance in the common-mode capacitances at two terminals of the flying capacitor 104.
4. Current leakage paths that can act on the flying capacitor 106.

It is highly impractical to address these causes individually, as mismatches and variations will always be present in the converter 100. Additionally, in modern portable devices the flying capacitor 106 voltage must dynamically track rapidly changing input voltage source 108, which can occur during load fluctuations or power plug-in events. The natural balancing mechanism is too slow to follow the dynamics of input voltage source 108.

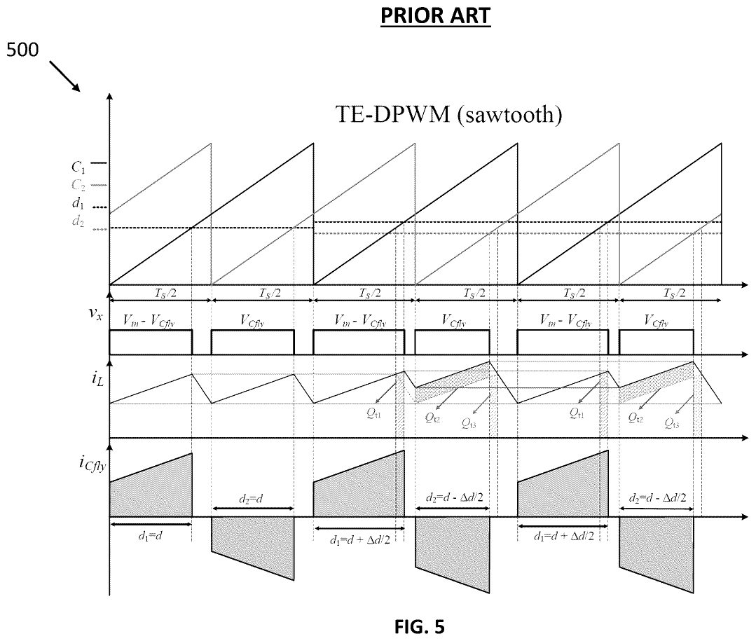

FIG. 5 is a known pulse width modulation active balancing graph 500 for the active flying capacitor 106.

FIG. 5 depicts one method of a differential duty cycle modulation of the converters 100 two PWM signals and depicts the Cfly balancing scheme failing at approximately 50% conversion ratio. The voltage is actively maintained with linear compensation controlled by flying capacitor 106 voltage error, with respect to 50% of the input voltage. FIG. 5 depicts the LCR operation exemplifying balancing action that attempts to charge the capacitor when the voltage is lower than the ideal 0.5*Vin, evident in opposing shifts of PWM1 and PWM2 rising edges.

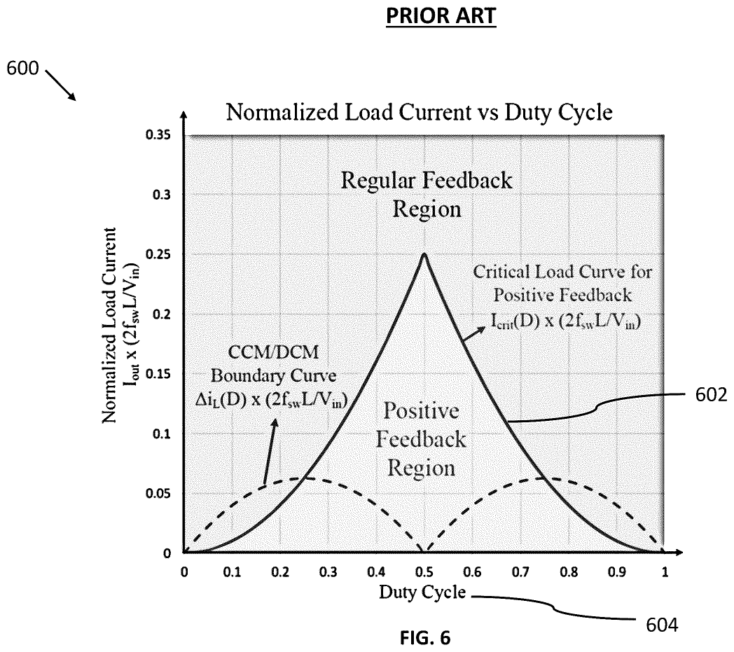

FIG. 6 illustrates an operating region graph 600 of a duty cycle 604 and the inductors 104 load current.

The conventional pulse width modulation balancing 500 can drastically fail at low current loads or near a 50% conversion ratio, as a feedback mechanism shifts from a negative feedback to a positive feedback. FIG. 6 depicts the positive operating region 602 where this failure happens and the relationship with the duty cycle 604.

Several techniques have been proposed that aim to overcome this issue but have limitations and they will now be described.

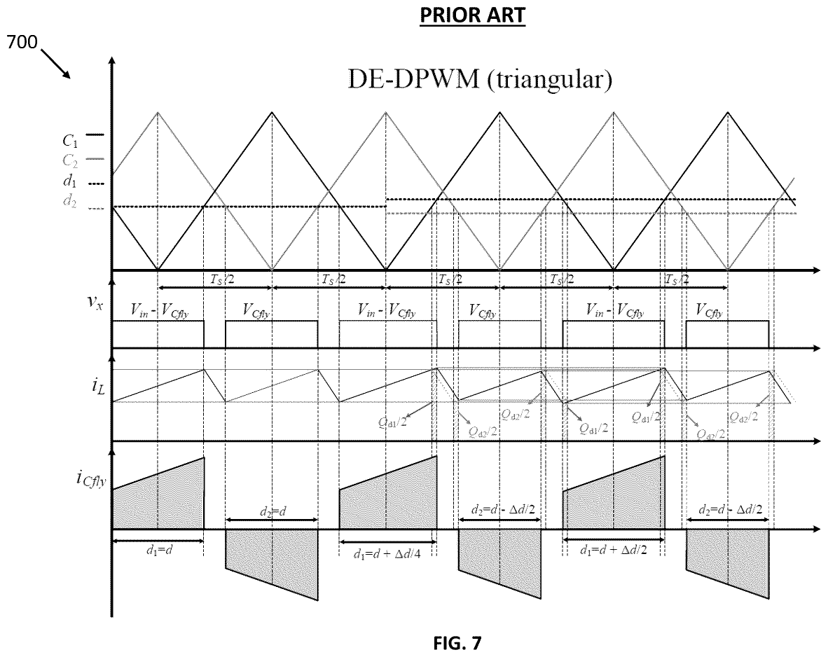

FIG. 7 illustrates a dual edge triangular modulation graph 700 for the 3-level converter 100.

A triangular waveform serves as a reference for determining when the leading and trailing edges of the PWM signal should switch states. It provides symmetry, ensuring consistent timing and equal opportunities for both edges to contribute to modulation. Both the leading edge (start of the pulse) and the trailing edge (end of the pulse) are adjusted relative to the triangular waveform. This creates a PWM signal where the pulse width is effectively controlled by the combined adjustments of both edges.

The dual edge triangular modulation graph 700 depicts the modulation of both a leading and a trailing edge through pulse width modulation using a triangular reference signal. By performing the triangular modulation, rather than just the trailing edge, the flying capacitor 106 dependence on the duty cycle operating region can be eliminated.

However, this method is ineffective within discontinuous conduction mode (DCM) of operation. DCM not only enhances light load efficiency but also prevents reverse current flow. This is crucial for facilitating a safe and reliable battery charging process, as reverse power flows can cause undesired voltage overstresses, which pose a destructive risk. Since DCM operation is essential in battery charging chips and other power converters in portable devices, the solution of dual edge triangular modulation 700 is not suitable.

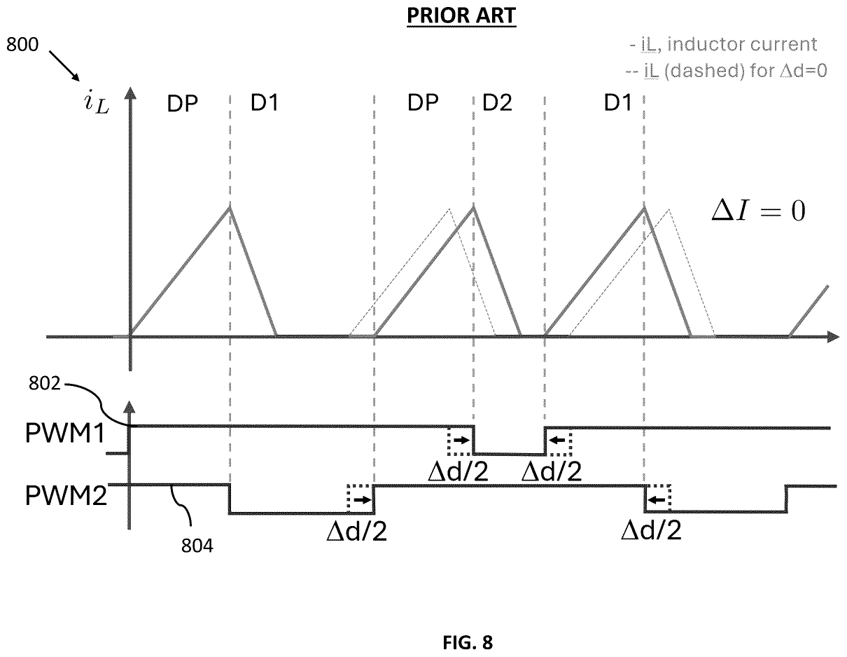

FIG. 8 illustrates a failure mechanism graph 800. FIG. 8 illustrates the dual edge triangular modulation scheme depicted in FIG. 7 failing in DCM HCR operation. The failure mechanism graph 800 depicts the synchronous modulation of the rising and falling edges of a first PWM signal 802 and/or a second PWM signal 804 does not produce a net change in the flying capacitor current during DCM, since the states responsible for charging and discharging the capacitor have equal durations and equal net currents regardless of the duty cycle shift.

As previously described, the loss of regulation in this region can lead to significant FET 102a, 102b, 102c, 102d overstress and safe-operating-area (SOA) violations, particularly during input voltage source 108 transitions.

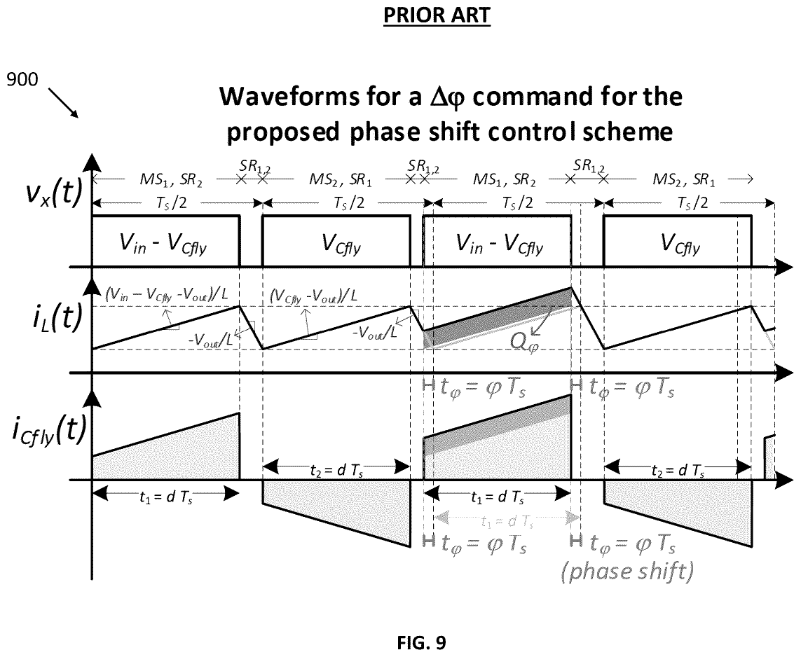

FIG. 9 illustrates a phase shift control scheme 900 using phase shift control.

In this case, the two PWM signals for controlling the switches 102a, 102b, 102c, 102d in the 3-level converter 100 are phase-shifted relative to each other while maintaining a fixed duty cycle. The relative phase shift determines the overlap or separation of the switching signals, which affects the timing of the charging and discharging cycles of the flying capacitor 106.

Since this technique is independent of the inductor current level, it does not exhibit instability typically seen around the 50% conversion ratio.

However, similar to the previous method 700, the phase shift control scheme 900 proves similarly ineffective during LCR DCM operation.

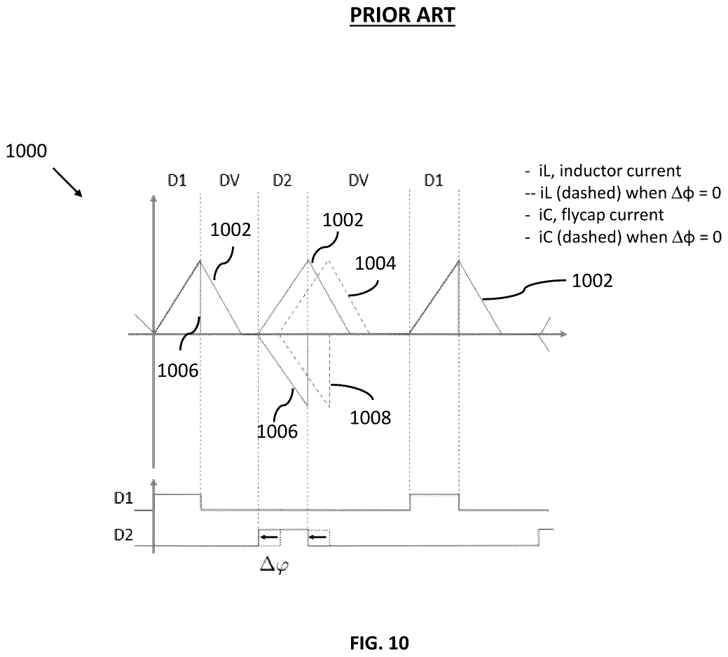

FIG. 10 illustrates a phase shifted control graph 1000 depicting the limitations of the phase shift control scheme 900 in LCR DCM.

The phase shifted control graph 1000 includes a first line plot 1002 depicting the inductor current (iL), The phase shifted control graph 1000 includes a first dashed line 1004 depicting the inductor current when the phase shift (ΔΦ) equals zero. The phase shifted control graph 1000 includes a second line plot 1006 depicting the flying capacitor current (iC). The phase shifted control graph 1000 includes a second dashed line plot 1008 depicting the flying capacitor current when the phase shift (ΔΦ) equals zero.

In LCR operation, the output voltage may be much smaller than the input voltage. In LCR, the PWM signals controlling the switches have a short duty cycle. The phase shift between the two PWM signals creates overlap or separation between the signals, which affects the timing of the flying capacitor charging (D1) and discharging (D2) states. However, when the duty cycle is very short (approaching 0%), where the PWM signal remains high (ON) for a very small portion of the switching period, there is limited overlap time. This reduces the influence of the phase shift on the flying capacitor correction current. Similarly, in deep high conversion ratio (HCR) operation, where the duty cycle is very high (approaching 100%), meaning the PWM signal remains high (ON) for nearly the entire switching period, the overlap becomes excessively large, and the phase shift's impact diminishes. When in the Magnetizing state the inductor 104 current is minimal in LCR. The small current means that the flying capacitor 106 receives only a weak correction current during the short intervals where phase shift might create a charging or discharging effect.

When in DCM operation, the phase shift method 1000 relies on a consistent overlap between PWM signals to induce a net correction current in the flying capacitor 106.

In DCM operation, the inductor current 104 becomes discontinuous, dropping to zero during a part of the switching cycle. This further limits the effectiveness of the phase shift method, especially when in LCR.

However, in DCM, the absence of inductor current at the start of Cfly charging and Cfly discharging states renders these timing adjustments ineffective in LCR, as there is no energy transfer adjustment to influence the capacitor voltage. Therefore, the combination of both LCR and DCM exacerbates the limitations of the phase shift method:

Further alternative solutions for balancing the flying capacitor 106 have included variations of the solutions 700, 900 already described, or disadvantageously involving either additional circuitry, such as the use of coupled inductors, or the addition of filtering components.

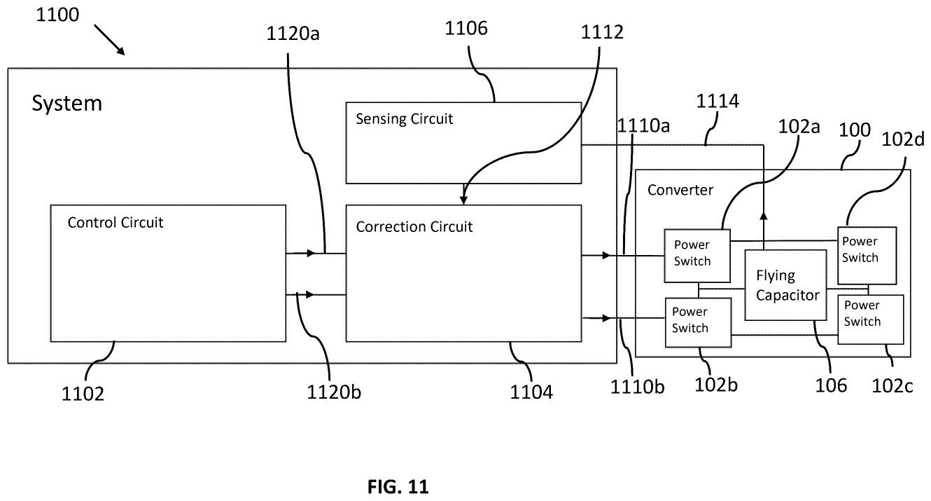

FIG. 11 is a schematic of a system 1100 for regulating the voltage of the converter 100 having the flying capacitor 106 in accordance with a first embodiment of the present disclosure.

The system 1110 includes a control circuit 1102 configured to generate a first pulse width control signal 1120a to control any combination of the power switches 102a, 102b, 102c or 102d. The first pulse width control signal 1120a determines a state of the first power switch and having a first rising edge and first falling edge. The control circuit may be configured to generate a second pulse width control signal 1120b to control an alternative power switch 102a, 102b, 102c, 102d to the first control signal 1120a.

The system 1110 may further include a correction circuit 1104 receiving the modulation signal 1112 and the first pulse width control signal 1120a and configured to modulate the first rising edge and/or first falling edge of the first pulse width control signal 1120 based on the sensing signal 1112 and generating a first correction signal 1110a to anyone one of the power switches 102a, 102b, 102c and 102d, thereby regulating the voltage of the flying capacitor 106. The correction circuit may receive the second pulse width control signal 1120b and is configured to modulate a second rising edge and/or second falling edge based on the modulation signal 1112 and generating a second correction signal 1110b to the power switch 102a, 102b, 102c, 102d.

Both PWM signals 1120a and 1120b may be initially generated by a closed-loop PWM scheme. Unlike any of the prior art described in FIGS. 2-10, where PWM may directly controls the power switches/FETs 102a, 102b, 102c, 102d, the PWM signals 1120a, 1120b are post-processed in the correction circuit 1112.

Based on flying capacitor 106 error information obtained by the sensing circuit 1106, the relative positions of the PWM1 1120a and PWM2 signals 1120b rising and falling edges are modulated. The modulation may be performed by an edge modulation method that integrates the strengths of both differential duty cycle modulation and phase shifting methods to guarantee complete control of the flying capacitor in all scenarios. Furthermore, it overcomes the inherit limitations of both, such as the instability in the vicinity of 50% operation and ineffectiveness in DCM operation. The edge modulation method may modulate the PWM edges as follows:
The rising edge of PWM1 1120a is not modulated in real-time.
Falling edge of PWM1 1120a is shifted in time by duration of d*Ts, time that corresponds to is differential duty cycle modulation.
Rising edge of PWM2 is shifted in time by duration (d+phi)*Ts time, the sum of phase shifting and differential duty cycle modulation gains.
Falling edge of PWM2 is shifted in by phi*Ts, time that corresponds to phase shifting technique.

### Wherein;

d represents the adjustment to the duty cycle (ON-time) of the PWM signal. “d” may be referred to as a differential duty cycle modulation parameter and may also be denoted as Δd.
It is derived from the flying capacitor's voltage error, aiming to correct imbalances in its charging or discharging cycles.
This modulation ensures that the flying capacitor achieves its target voltage over time.
Φ/phi represents the phase shift applied to the PWM signal relative to another PWM signal (e.g., PWM1). “phi” may be referred to as the phase shift parameter and may also be denoted as Δφ.
Phase-shifting adjusts the relative timing between PWM signals, influencing the overlap or separation of switching states. This is critical for balancing the flying capacitor in scenarios where duty cycle modulation alone is insufficient, such as in high conversion ratio (HCR) in discontinuous conduction mode (DCM).
Ts is the switching period, the duration of one full PWM cycle (the reciprocal of the switching frequency).

The 3-edge modulation method results in the correction signals (CS1) 1110a and (CS2) 1110b ON-times are different by 2*d. CS1 and CS2 introduce the flying capacitor 106 regulation properties of differential duty cycle modulation.

Additionally, the operation also introduces phase shifting properties by relatively shifting in time the centres of the PWM1 1120a and PWM2 1120b pulses by phi*Ts, enhancing the gain of the system. In LCR operation, the relationship describing the flying capacitor correction currents as a function of circuit parameters, i.e., gain, can be derived as follows:

$${i}_{Cfly} \approx 2 {I}_{L} Δ d + \frac{{V}_{out}}{{f}_{s} L} D Δφ \qquad ( 1 )$$

### Wherein:

ICfly represents the net current flowing into or out of the flying capacitor 106.
I_{L} is inductor 104 current, the average current flowing through the converter's 100 inductor 104.
Δd represents the change in duty cycle (ON-time adjustment) applied to the PWM signal to control the flying capacitor 106 voltage. Ad may be referred to as the differential duty cycle modulation parameter.
Vₒᵤₜ represents the output voltage of the converter 100, which relates to the energy transfer required to regulate the flying capacitor 106 voltage.
fₛ represents the switching frequency of the converter 100 switching cycles between full state sequences.
L represents the value of the inductor in the converter circuit.
D is the duty cycle without the differential duty cycle applied.
Δφ represents the duty cycle phase shift introduced between the PWM signals to regulate the flying capacitor 106 voltage. Δφ may be referred to as the phase shift parameter.

Whereas in HCR operation the edge correction control signals can be derived from:

$${i}_{Cfly} \approx 2 {I}_{L} Δ d + \frac{{V}_{i n} - {V}_{out}}{{f}_{s} L} ( 1 - D ) Δφ \qquad ( 2 )$$

### Wherein:

Vᵢₙ represents the input voltage source 108 of the converter 100.

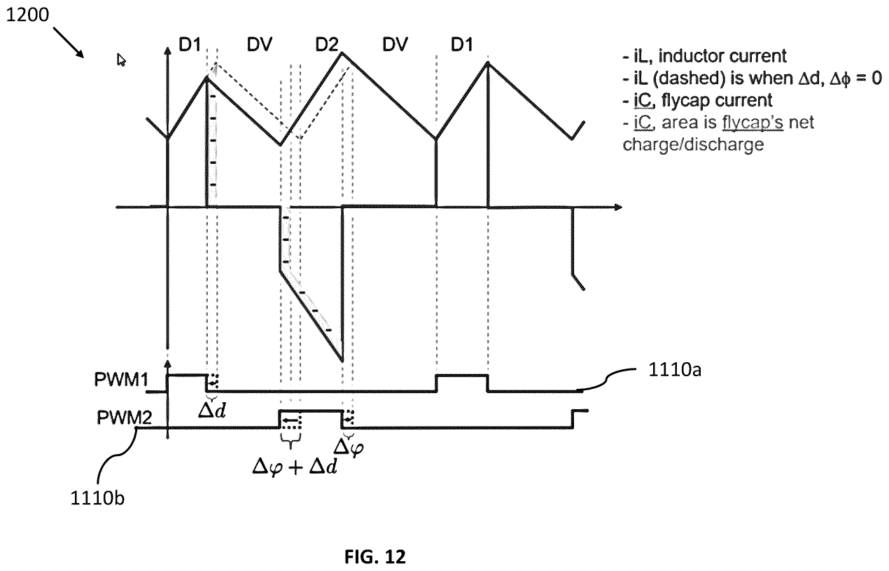

FIG. 12 is graph of a 3-edge modulation operation 1200 for the edge modulation in accordance with the first embodiment of the present disclosure.

The 3-edge modulation graph 1200 depicts the two digital correction signals 1110a, 1110b that govern the operation of the 3-level converter 100. In this example, the first correction signal controls switches 102a and 102d in a complementary manner, and second correction signal 1110b, which controls switches 102b and 102c in complementary manner as well.

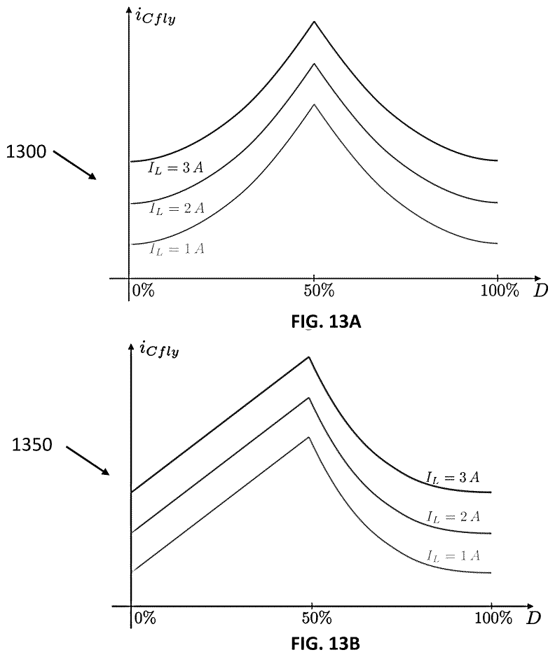

FIG. 13A is a graph illustrating a first gain profile 1300 for the edge modulation method for when input voltage source 108 is constant in accordance with the first embodiment of the present disclosure. FIG. 13B is a graph illustrating a second gain profile 1350 when the output voltage of the converter 100 is constant in accordance with the first embodiment of the present disclosure.

The gain relationships the first gain profile 1300 and 1350 do not change polarity with respect to the positive average inductor 104 current because other parameters, such as inductance, switching frequency and output voltage are greater than zero. The polarity remains positive as long as the inductor 104 current is positive, thereby eliminating the instability in the 50% region.

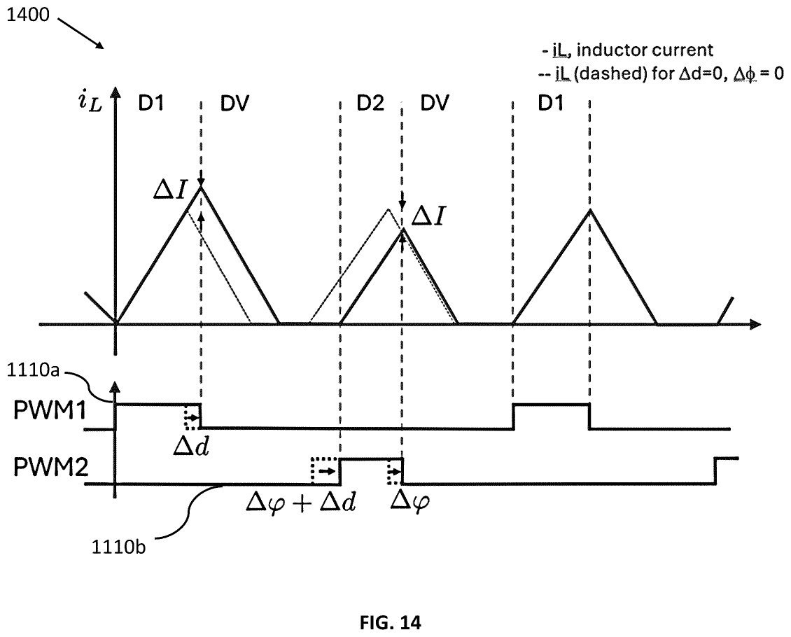

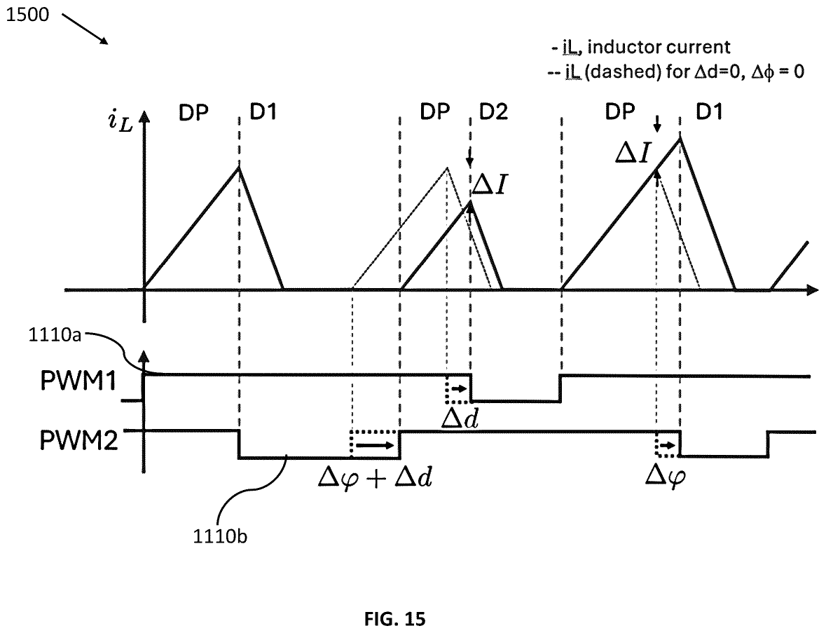

FIG. 14 is a graph of an LCR DCM operation 1400 in accordance with the first embodiment of the present disclosure. FIG. 15 is graph of an HCR DCM operation 1500 in accordance with the first embodiment of the present disclosure.

FIGS. 14 and 15 depict the edge correction method effectiveness in both LCR DCM and HCR DCM operation. The mechanism for balancing in LCR DCM comes from the duty cycle differential. In LCR 1400, the duration of Cfly charging state is dictated by the pulse width of first control signal 1110a, while the duration of the discharging state is determined by the pulse width of second control signal 1110b. The edge correction method enforces a differential timing between these two pulses based on the Cfly error, thus altering net flying capacitor current.

The ability to regulate in HCR DCM operation 1500 stems from the phase shifting properties. Since the inductor 104 current peaks are determined by the duration of the overlap time between PWM signals 1120a, 1120b, the edge method simultaneously alters both rising and falling edge of 1120b to transmit the control signal 1110b thereby differentially manipulating the Cfly 104 current in charging and discharging states, thereby controlling net Cfly current on a cycle-by-cycle basis.

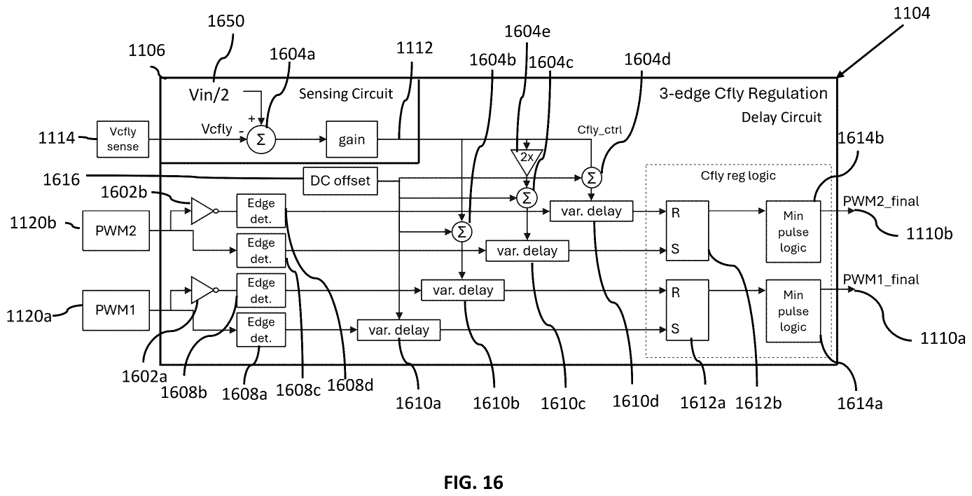

FIG. 16 is a diagram of the correction circuit 1112 and the sensing circuit 1106 receiving the Cfly voltage 1114 in accordance with the first embodiment of the present disclosure.

The correction circuit 1112 may include a pair of gates 1602a, 1602b, such as the NOT gates, depicted in FIG. 16. As correction circuit receives PWM1 1120a and PWM2 1120b the signals may be subsequently split into the pair of gates 1602a, 1602b and a gateless pathway.

The correction circuit 1112 may include a plurality of edge detection components, such as 4 edge detection components 1608a, 1608b, 1608c, 1608d depicted in FIG. 16. The edge detection components 1608a, 1608b, 1608c, 1608d are circuits or devices that detect and respond to changes in signal states, specifically the rising edges (low-to-high transitions) and falling edges (high-to-low transitions) of pulse-width modulation (PWM) signals 1120a, 1120b.

The correction circuit 1112 may include one or more delay elements, such as the 4 delay elements 1610a, 1610b, 1610c, 1610d depicted in FIG. 16. The variable delay elements 1610a, 1610b, 1610c, 1610d are responsible for dynamically adjusting the timing of the rising and falling edges of the pulse-width modulation (PWM) signals based on the gain adjusted signal 1112 derived from the flying capacitor voltage error 1114. These delay elements 1610a, 1610b, 1610c, 1610d introduce precise and adjustable delays to achieve accurate timing control of the PWM signals.

The correction circuit 1112 may include a plurality of operators, such as the adders 1604b, 1604c, 1604 and the multiplier 1604e depicted in FIG. 16. The adders 1604b, 1604c, 1604 are arithmetic components used to combine multiple inputs, such as a DC offset and then gain adjusted voltage error signal 1112. The multiplier 1604e doubles the value received from the gain 1112.

In the configuration depicted in FIG. 16, the correction circuit 1112 may modulate the first rising edge equal to a first constant. The correction circuit 1112 may modulate the first falling edge equal to the differential duty cycle modulation parameter and/or a phase shift parameter multiplied by a first modulation variable. The correction circuit 1112 may modulate the second rising edge equal to double the differential duty cycle modulation parameter and/or a phase shift parameter multiplied by a first modulation variable. The correction circuit 1112 may modulates the second falling edge equal to the differential duty cycle modulation parameter and/or a phase shift parameter multiplied by a first modulation variable.

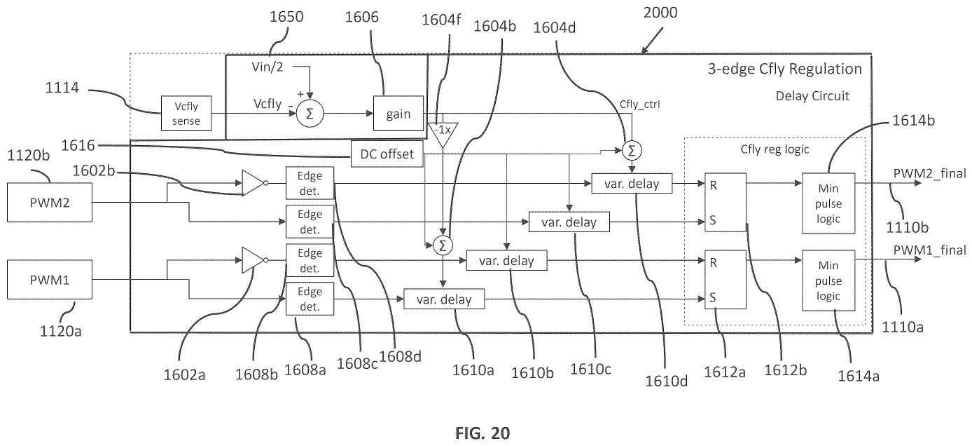

An alternative embodiment of these modulations will be described with reference later to FIG. 20.

The correction circuit 1112 may include a Set-Reset (SR) latch 1612a, 1612b which operates to recreate the pulse-width modulation (PWM) signals based on the flying capacitor error voltage 1114, which in this case is receiving inputs from delay elements 1610a and 1610b.

The correction circuit 1112 may include a minimum pulse logic component 1614a, 161b, that ensures that the final PWM control signal 1110a, 1110b meet the required timing constraints before it is transmitted to control the switches 102a, 102b, 102c, 102d. The minimum pulse logic component 1614a, 1614b, can ensure that the PWM signal has a minimum duration for the ON state (switch is closed) and the OFF state (switch is open).

The sensing circuit 1106 may include an operator, such as subtractor 1604a that receives the sense voltage signal 1114 and a reference signal 1650. The substractor 1604a may then transmit the voltage error of the flying capacitor 106 to the gain adjustment 1112, which in turn amplifies the voltage error signal.

A general description of the operation of FIG. 16 is now provided. The four variable delay elements 1610a, 1610b, 1610c, 1610d may control the PWM signals 1120a, 1120b: two for the rising and falling edges of PWM1 1120a and two for the rising and falling edges of PWM2 1120b, as illustrated. Although the delay for the rising edge of PWM1 1120a remains constant, it nominally matches the delay of the other three elements. The delay element responsible for PWM2 1120b rising edge has double the delay for the input signal compared to the other 2 variable delays 1604d, 1604c, because Δd=Δφ. The delayed edges are then reconstructed using an SR latch circuit 1612a, 1612b.

Additionally, the minimum pulse block 1614a can be incorporated to ensure the minimum PWM turn on and off times. This block would produce one-shot pulses with each edge, masking the corresponding signal during the pulse period. For instance, a rising edge on PWM 1120a, 1120b would generate a minimum on-time pulse, during which any logic low from the SR latch 1612a, 1612b output would be ignored, ensuring minimum on-time. A similar mechanism applies for the minimum off-time, during which any logic high from the SR latch 1612a, 1612b output would be ignored

The correction circuit 1104 possess flexibility to switch and emulate properties of other methods as the proposed implementation in FIG. 16 relies on post processing PWM signals using variable delay elements 1610a, 1610b, 1610c, 1610d and their variable inputs 1604b, 1604c, 1604d, 1604e.

In an alternative embodiment, it is possible to reroute the variable delay input paths 1604b, 1604c, 1604d, 1604d and realize alternative flying capacitor regulation schemes, including phase shifting or differential duty cycle modulation.

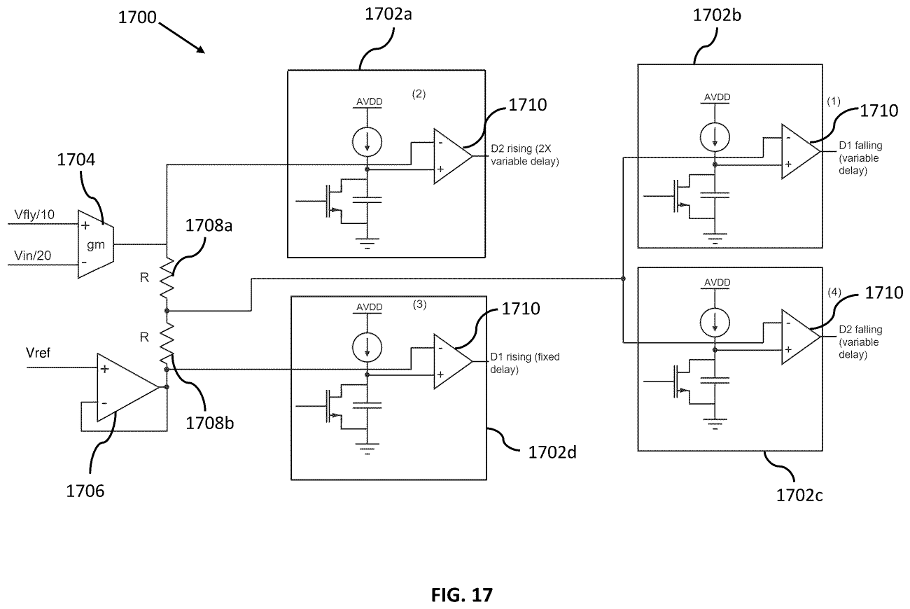

FIG. 17 is a schematic of a first implemented correction circuit 1700 in accordance with a second embodiment of the present disclosure.

The implemented correction circuit 1700 may include a transconductance (Gm) Amplifier 1704 which generates a current proportional to the flying capacitor 106 voltage error and produces a voltage differential across a series of two resistors 1708a, 1708b, providing the varying threshold voltage required for modulation. The voltage ramp may be a constant ramp rate and a varying signal proportional to the Cfly error. The notable advantage of this approach is linearity across the entire operating mode range.

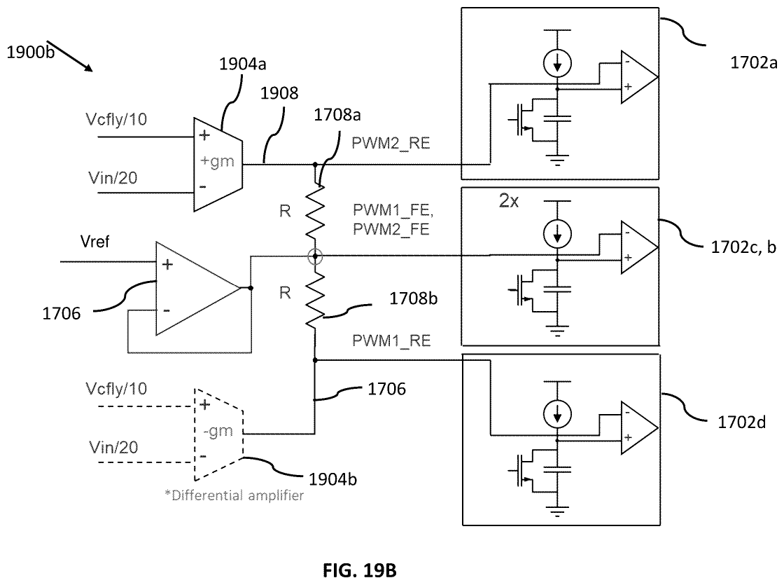

In an alternative embodiment relating to FIG. 17 will be described later in the application with reference to FIG. 19.

The implemented correction circuit 1700 may include a Vref Buffer 1706 that supplies a static reference voltage, which in a non-limiting example may be 1V for consistent ramp generation.

The implemented correction circuit 1700 may include 4 Current-on-Capacitor (IonC) delay elements 1702a, 1702b, 1702c, 1702d configured to implement delay timing adjustments for the rising and falling edges of PWM1 1120a and PWM2 1120b. The IonC delay elements 1702a, 1702b, 1702c, 1702d may share any features previously described for delay elements 1610a, 1610b, 1610c, 1610d. Each IonC delay element 1702a, 1702b, 1702c, 1702d may include a comparator 1710.

It will be appreciated that IonC delay elements 1702a, 1702c, 1702c, 1702d are but one implementation 1700 of the present disclosure and other alternative delays schemes may be considered. For example, the delay element 1702a, 1702b, 1702c and 1702d may comprise the comparator circuit configured to compare the modulation signal with the ramp signal and generate the control signal. While this implementation utilizes the comparator 1710 and reference signal, alternative delay element designs are also possible, such as a current-starved delay elements, which do not require a comparator. The current-starved delay element may control the delay of the PWM signals (e.g., the rising and/or falling edge) by limiting the current available to charge or discharge the input capacitance of a gate, wherein the “starving” of the current is controlled by additional transistors that act as programmable current sources, restricting the amount of current flowing through the gate.

Further alternative embodiments may be implemented by those skilled in the art, such as; a digital delay line including a series flip-flops or a series of shift registers to propagate the input signal; or a ring oscillator to generate delay using a circuit loop of inverters; or a voltage-controlled oscillator (VCO) or voltage-controlled RC network to adjust delay timing dynamically based on a control voltage.

In present implemented correction circuit 1700, the IonC ramp and varying voltage threshold intersect, the comparator 1710 generates a single pulse to indicate the corresponding edge of the PWM signal 1120a, 1120b. The IonC delay element for the rising edge of PWM1 observes a constant Vref voltage, and therefore remains unchanged regardless of Cfly error. The falling edge delays for both PWM1 1120a and PWM2 1120b observe varying voltage of Vref+I_{gm}*R, while PWM2's rising edge delay see twice this differential voltage, Vref+2*I_{gm}*R, consequently, the delay difference between the two is double.

### Wherein:

Vref (Fixed Voltage)
I_{gm} (Transconductance Current)
R the resistor to which I_{gm} flows.

The pulses corresponding to the rising and falling edges of PWM1/2 1120a, 1120b are fed to a set-reset latch 1612a, 1612b to reconstruct the modulated PWM signals that ultimately control the power switches 102a, 102b, 102c, 102d. To preserve signal integrity, the SR latch 1612a, 1612b may need to account for scenarios where delayed edge sequences have reversed order due to significant Cfly errors, but only if such scenarios can occur.

Alternatively, reference voltage of Vref connected to the bottom of the resistor 1708b in FIG. 17 can also be connected to other points along the 2R resistor network without changing the gain, as long as both resistors 1708a, 1708b are subject to the same current flow. For instance, it can be connected at the top node or any intermediate point between the top and bottom nodes of the 2R network. This modification would affect which edges are shifted while maintaining the same gain profile. The rationale for this adjustment could be to optimize the analog implementation for different common mode voltage ranges, or if the flying capacitor 106 inherently tends to drift towards a specific non-ideal voltage.

In a specific alternative embodiment, when Vref is connected to the centre node of the 2R network, the rising edge of PWM1 1120a may be modulated; the falling edge of PWM1 1120a may not be modulated; the rising edge of PWM2 1120b may be modulated and falling edge of PWM2 1120b may not be modulated.

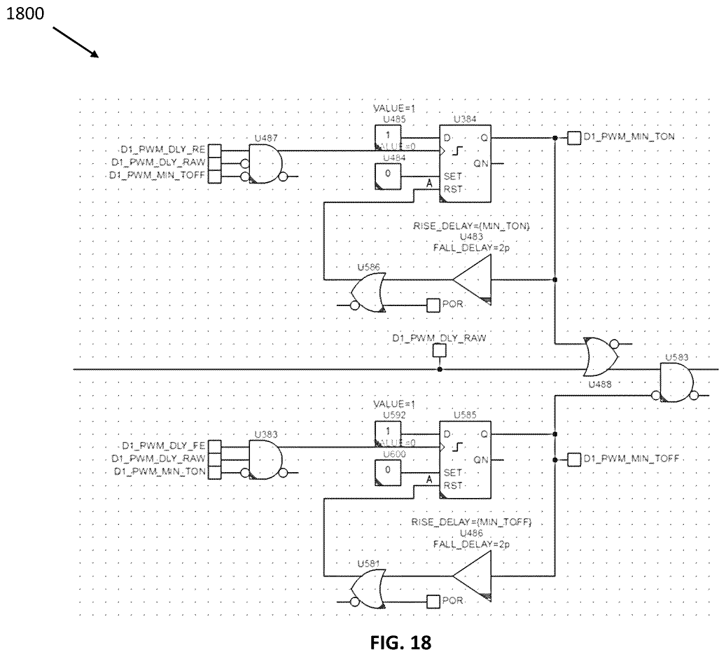

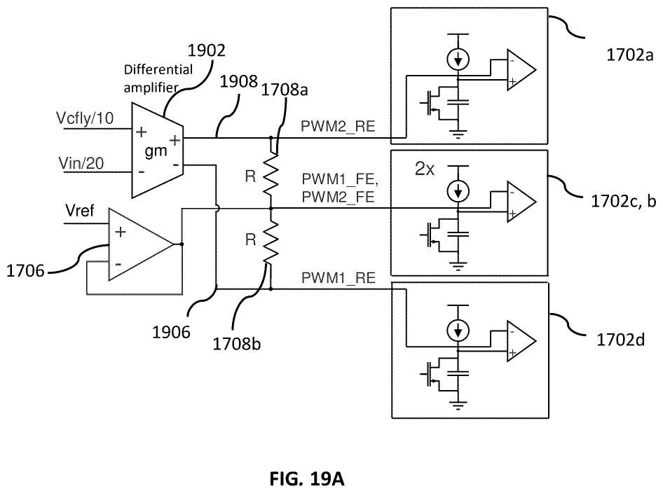

FIG. 18 is a schematic of a correction circuit 1800 configured to initiate one-shot pulses of a minimum on or off duration in accordance with a third embodiment of the present disclosure.

The correction circuit 1800 may share any component previously described with correction circuit 1112 or the implemented correction circuit 1700.

The correction circuit 1800 is configured to initiate one-shot pulses of the minimum on or off duration thereby masking the outputs using a logic “and” and a “or” gates. The correction circuit 1800 uses the one-shot pulses to control the PWM output 1110a, 1110b, ensuring the signals comply with the minimum on/off duration requirements. The minimum time pulses are triggered by corresponding edge signals, if the opposite pulse is not already engaged. For example, the generation of minimum time pulses is triggered by rising edges or falling edges of the PWM signal 1120a, 1120b:
a rising edge starts the ON period, which triggers a minimum ON pulse.
a falling edge starts the OFF period, which triggers a minimum OFF pulse.

The correction circuit 1800 ensures compliance with a minimum on-time (Ton Min) and a minimum off-time (Toff Min) requirement by initiating one-shot pulses when the processed PWM pulses are smaller than the specified Ton Min or Toff Min durations. This mechanism effectively masks signals that would otherwise violate these timing constraints, preserving the integrity and stability of the PWM operation.

FIG. 19A is a schematic of a second implemented correction circuit 1900a in accordance with a fourth embodiment of the present disclosure. FIG. 19B is a schematic of a third implemented correction circuit 1900b in accordance with a fifth embodiment of the present disclosure.

The second implemented correction circuit 1900a and the third implemented correction circuit 1900b may share all components previously discussed for the first implemented correction circuit 1700 and where possible reference numerals have been kept the same.

The second implemented correction circuit 1900a includes a differential transconductance (Gm) amplifier 1902 having a negative node output and positive node output. The negative node is in communication with delay elements 1702d via a first connection 1906. The positive node is in communication with delay elements 1702a via a second connection 1908.

The third implemented correction circuit includes a first differential amplifier 1904a having a positive polarity (+gm) and a second differential amplifier 1904b having a negative polarity 1904b. The negative node is in communication with delay elements 1702d via a first connection 1906. The positive node is in communication with delay elements 1702da via a second connection 1908. The second differential amplifier 1904b is in communication with delay elements 1702d via the first connection 1906. The second differential amplifier 1904a is in communication with delay elements 1702a via a second connection 1908.

The second implemented correction circuit 1900a and third implemented correction circuit 1900b may include an integral gain component that generates an integral current.

The second implemented correction circuit 1900a and third implemented correction circuit 1900b may not require a Vref buffer 1706 for signal decoupling.

FIG. 20 is a diagram of a second correction circuit 2000 and the sensing circuit 1106 receiving the Cfly error 1114 in accordance with the sixth embodiment of the present disclosure.

The second correction circuit 2000 may share components with correction circuit 1112 previously described and where possible all the reference numerals have been kept the same.

The second correction circuit 2000 may include a multiplier 1604f that multiplies the gain 1606 by negative 1.

In the configuration depicted in FIG. 20, the correction circuit 2000 may modulate the first rising edge to equal −1 multiplied by the first modulation variable. The correction circuit 2000 may modulate the first falling edge equal to the first falling edge equal to a first constant. The correction circuit 2000 may modulate the second rising edge equal to the second rising edge a first constant. The correction circuit 1112 may modulate the second falling edge equal to the second falling edge equal to 1 multiplied by the first modulation variable.

It will be appreciated that references to a first pulse width modulated signal is simply a naming convention and it may refer to either PWM1 1120a or PWM2 1120b. Likewise, an additional reference to second pulse width control signal may refer to PWM2 1120b or PWM1 1120a that was not selected to define the first pulse width modulated signal.

1. A control system for a switching converter comprising a flying capacitor and a first power switch, the control system comprising:
a control circuit configured to generate a first pulse width control signal to control the first power switch, the first pulse width control signal determining a state of the first power switch and having a first rising edge and first falling edge;
a sensing circuit configured to sense a voltage error of a flying capacitor voltage of the flying capacitor relative to a target voltage and generate a modulation signal based on the voltage error of the flying capacitor voltage; and
a correction circuit configured to receive the modulation signal and the first pulse width control signal and configured to modulate the first rising edge and/or the first falling edge based on the modulation signal to provide a corrected first pulse width control signal to the first power switch, thereby regulating the flying capacitor voltage of the flying capacitor.

2. The control system of claim 1, wherein:
the switching converter comprises a second power switch;
the control circuit is configured to generate a second pulse width control signal to control the second power switch, the second control signal determining the state of the second power switch and having a second rising edge and second falling edge; and
the correction circuit is configured to receive the second pulse width control signal and is configured to modulate the second rising edge and/or the second falling edge based on the modulation signal to provide a corrected second pulse width control signal to the second power switch.

3. The control system of claim 2, wherein:
the switching converter comprises a third power switch and the correction circuit is configured to provide the corrected first pulse width control signal to the third power switch, the state of the third power switch being complementary to the inverse state of the second power switch as controlled by the corrected second pulse width control signal; and/or
the switching converter comprises a fourth power switch and the correction circuit is configured to provide the corrected second pulse width control signal to the fourth power switch, the state of the fourth power switch being complementary to the inverse state of the first power switch as controlled by the corrected first pulse width control signal.

4. The control system of claim 3, wherein the correction circuit is configured to:
modulate the first rising edge and/or the first falling edge based on a differential duty cycle modulation parameter and/or a phase shift parameter; and/or
modulate the second rising edge and/or the second falling edge based on the differential duty cycle modulation parameter and/or the phase shift parameter.

5. The control system of claim 4, wherein:
the correction circuit is configured to modulate the first falling edge based on the differential duty cycle modulation parameter; and/or
the correction circuit is configured to modulate the second rising edge based on the differential duty cycle modulation parameter and the phase shift parameter; and/or
the correction circuit is configured to modulate the second falling edge based on the phase shift parameter.

6. The control system of claim 5, wherein the correction circuit comprises a plurality of delay elements configured to independently modulate one, two, three or four of:
the first rising edge;
the first falling edge;
the second rising edge; and
the second falling edge.

7. The control system of claim 6, wherein the correction circuit is configured to modulate:
the first rising edge equal to a first constant;
the first falling edge equal to the differential duty cycle modulation parameter and/or a phase shift parameter multiplied by a first modulation variable;
the second rising edge equal to double the differential duty cycle modulation parameter and/or a phase shift parameter multiplied by a first modulation variable; and
the second falling edge equal to the differential duty cycle modulation parameter and/or a phase shift parameter multiplied by a first modulation variable.

8. The control system of claim 6, wherein the correction circuit is configured to modulate:
the first rising edge equal to −1 multiplied by a first modulation variable;
the first falling edge equal to a first constant;
the second rising edge a first constant;
the second falling edge equal to 1 multiplied by the first modulation variable.

9. The control system of claim 6, wherein the first correction signal to the first power switch is generated based on:
$${i}_{Cfly} \approx 2 {I}_{L} Δ d + \frac{{V}_{o u t}}{{f}_{s} L} D Δφ ;$$
and/or:
the first correction signal to the first power switch is generated in based on:
$${i}_{Cfly} \approx 2 {I}_{L} Δ d + \frac{{V}_{i n} - {V}_{o u t}}{{f}_{s} L} ( 1 - D ) Δφ .$$

10. The control system of claim 6, wherein at least one of the plurality of delay elements is adjustable based on the modulation signal for precise timing control of the first pulse width control signal and/or the second pulse width control signal.

11. The control system of claim 10 wherein the sensing circuit comprises a transconductance amplifier configured to generate a modulation signal based on a proportional current to the voltage error of the flying capacitor.

12. The control system of claim 11, wherein the transconductance amplifier comprises an integral gain component having an integral current and wherein the ramp signal is based on the combination of the proportional current and the integral current.

13. The control system of claim 12 wherein the sensing circuit comprises:
a buffer configured to stabilize a reference signal having a static reference voltage.

14. The control system of claim 13, wherein the correction circuit comprises a comparator circuit configured to compare the reference signal based on the modulation signal with the ramp signal and generate the control signal.

15. The control system of claim 14, wherein the comparator circuit includes a resistor ladder network configured to adjust the control signals delay through comparison with the ramp signal.

16. The control system of claim 15, wherein the control circuit is configured to regulate the voltage of the flying capacitor configured to operate within a continuous conduction mode (CCM) and a discontinuous conduction mode (DCM) operation and across a plurality of operating regions comprising:
a low conversion ratio (LCR);
a high conversion ratio (HCR); and
a 50% conversion ratio operation.

17. The control system of claim 16, wherein the converter comprises an input voltage and the sensing circuit is configured to:
measure the input voltage of the converter; and/or
measure output voltage of the converter.

18. The control system of claim 17, wherein the control circuit and the correction circuit are configured to provide stable regulation of the flying capacitor voltage during transitions between continuous conduction mode (CCM) and discontinuous conduction mode (DCM) operation.

19. The control system of claim 18, wherein the modulation signal is generated to maintain the voltage of the flying capacitor at approximately half the input voltage of the converter.

20. A method of controlling a switching converter comprising a flying capacitor and a first power switch, the method comprising:
generating a first pulse width control signal to control the first power switch, the first pulse width control signal determining a state of the first power switch and having a first rising edge and first falling edge;
sensing a voltage error of the flying capacitor relative to a target voltage and generating a modulation signal based on the voltage error of the flying capacitor; and
modulating the first rising edge and/or the first falling edge based on the modulation signal to provide a corrected first pulse width control signal to the first power switch, thereby regulating the flying capacitor voltage of the flying capacitor.
